(19) United States
(12) Patent Application Publication
(10) Pub. No.: US 2014/0356755 A1
(43) Pub. Date: Dec. 4, 2014

(54) Catalyst Polymer Inks

(71) Applicant: ITM Power (Research) Limited, Sheffield (GB)

(72) Inventors: Nick Van Dijk, Sheffield (GB); Kevin Yeomans, Sheffield (GB)

(73) Assignee: ITM Power (Research) Limited, Sheffield (GB)

(21) Appl. No.: 14/292,370

(22) Filed: May 30, 2014

(30) Foreign Application Priority Data
May 31, 2013 (GB) 1309806.6

(51) Int. Cl. H01M 4/86; C25B 11/04; C25B 13/08; B01D 67/00; H01M 4/88

(52) U.S. Cl. CPC H01M 4/8663; B01D 67/0088; H01M 4/8878; H01M 4/8828; C25B 13/08; C25B 11/0489
USPC 429/479; 502/159; 502/158; 502/5; 427/115; 204/296; 204/282

(57) ABSTRACT

A method of forming a catalyst ink is disclosed. The method can include: polymerising an ionic monomer and at least one non-ionic monomer to form a hydrophilic polymer; dissolving the hydrophilic polymer in a suitable solvent to form a polymer solution; and mixing a catalyst with the polymer solution to make a catalyst ink. Also disclosed are catalyst inks formed from this method, as well as membranes including the catalyst inks and methods for forming the same.

### CROSS-REFERENCE TO A RELATED APPLICATION

This application claims priority to Great Britain Application No. 1309806.6, filed May 31, 2013; which is incorporated herein by reference in its entirety.

### FIELD OF THE INVENTION

The present invention relates to catalyst inks, and methods of depositing them onto membranes for use in electrochemical cells.

### BACKGROUND OF THE INVENTION

Conventionally, a polymer membrane is formed, and then a catalyst is deposited onto the surface of the membrane to form a catalyst-coated membrane.

Forming polymer catalyst inks for deposition onto polymer membranes is another way of forming a catalyst-coated membrane. It is known that membrane solutions such as Nafion® can be used to form catalyst inks. However, Nafion® has many drawbacks as a membrane for use in electrochemical cells. For example, it is not a hydrophilic polymer and requires continuous hydration in order to operate in an electrochemical cell.

### SUMMARY OF THE INVENTION

It has surprisingly been found that membranes of the type described in WO03/023890, which is incorporated herein by reference in its entirety, and also related hydrophilic membranes, can be used to form a lower cost catalyst ink with a higher ionic conductivity when compared to the inks formed using Nafion®.

According to a first aspect, the present invention is a method of forming a catalyst ink, the method comprising:

polymerising an ionic monomer and at least one non-ionic monomer to form a hydrophilic polymer;

dissolving the hydrophilic polymer in a suitable solvent to form a polymer solution; and

mixing a catalyst with the polymer solution to make a catalyst ink.

According to a second aspect, the present invention is a catalyst ink formed from a method disclosed above.

According to a third aspect, the present invention is a method of forming a catalyst ink-coated membrane, the method comprising:

polymerising an ionic monomer and at least one non-ionic monomer to form a hydrophilic polymer;

polymerising an ionic monomer and at least one non-ionic monomer to form a hydrophilic polymer;

dissolving the hydrophilic polymer in a suitable solvent to form a polymer solution;

mixing a catalyst with the polymer solution to make a catalyst ink;

depositing the catalyst ink onto a membrane; and

removing the solvent to form a catalyst ink-coated membrane.

According to fourth and fifth aspects, the present invention is a catalyst ink-coated membrane and membrane electrode assemblies formed from a method disclosed above.

### BRIEF DESCRIPTION OF DRAWINGS

FIG. 1 shows a plot of stress versus strain.

### DESCRIPTION OF THE PREFERRED EMBODIMENTS

As used herein, the term hydrophilic polymer has the standard meaning in the art. It is understood by a person skilled in the art of polymer chemistry, to mean “a polymer which dissolves in water”. To make them useful in industry, hydrophilic polymers are commonly cross-linked, which renders them insoluble. A cross-linked hydrophilic polymer is not soluble in water (but it has an affinity for water), but if those cross-links were removed, the polymer would dissolve in water. Nafion®, for example, is not a hydrophilic polymer.

It is well known that any cross-linked polymer is unable to be dissolved in any solvent.

An ionic monomer is a monomer comprising an ionic group. Preferably, the ionic monomer is a monomer comprising an acid group. More preferably, the strong acid group is a sulphonic acid group. The ionic monomer may instead comprise a basic group. An example of a strongly basic group is a quarternary ammonium group.

The ionic monomer may be selected from 2-acrylamido-2-methyl-1-propanesulphonic acid (AMPSA), vinylsulphonic acid (VSA), styrenesulphonic acid (SSA), 2-sulphoethyl methacrylate (SOMA) and 3-sulphopropyl methacrylate, Na salt (SPM). Preferably, the ionic monomer is AMPSA.

In a preferred embodiment, the at least one non-ionic monomer comprises a hydrophobic monomer, preferably selected from methyl methacrylate (MMA), acrylonitrile (AN), methacryloxypropyltris (trimethylsiloxy) silane (TRIS), 2,2,2-trifluoroethyl methacrylate (TRIF) and styrene (STY). Preferably, the at least one non-ionic monomer comprises AN. Preferably, it is AN.

In a preferred embodiment, the polymerisation is UV polymerisation. Gamma and Thermal polymerisation are further examples of methods suitable for use in the invention. If UV polymerisation is to be used, then preferably, the components to be polymerised also comprise a UV initiator.

Preferably, the at least one non-ionic monomer comprises a hydrophilic monomer, preferably selected from methacrylic acid (MA), 2-hydroxyethyl methacrylate (HEMA), ethyl acrylate (EA), 1-vinyl-2-pyrrolidinone (VP), propenoic acid 2-methyl ester (PAM), monomethacryloyloxyethyl phthalate (EMP), ammonium sulphatoethyl methacrylate (SEM).

Preferably, the ionic monomer comprises an acid group, wherein the acid group is reacted with methylimidazole before polymerisation to form an ionic liquid, and then converted back to the acid group after polymerisation. Preferably, it is converted back to the acid group after the catalyst ink has been deposited on a membrane and the solvent removed. Preferably, the conversion is carried out by ion-exchange, preferably using a strong acid such as sulphuric acid. Preferably, the membrane is washed with water after the conversion.

Without wishing to be bound by theory, it is believed that the reaction of the methylimidazole with the strong acid group in the monomer, forms an ionic liquid, which is miscible with the other monomer component, and allows for the formation of a homogeneous polymer, without the use of water. Although the use of water is not precluded in the present invention, in one embodiment, the components to be polymerised preferably do not comprise water.

In a preferred embodiment, the composition, i.e. the catalyst ink, is cross-linked. As cross-linked polymers are insoluble, the polymer should not cross-link before the ink is formed, i.e. before it is dissolved in a solvent and the catalyst added. Therefore, if it is desired to have the catalyst-ink cross-linked, the cross-linker should not form a cross-linked membrane until after the polymer is dissolved. Suitable cross-linkers exist, for example, those that cross-link after exposure to an external stimulus, such as water or heat.

The cross-linking may add additional strength to the polymer. Preferably, the cross-linker is a silane monomer, such as vinyltrimethoxysilane or methacryloxpropyltrimethoxysilane, which is added to the components to be polymerised, such that the resulting polymer will cross-link on exposure to water, or a humid atmosphere. Other suitable cross-linkers are protected isocyanates. The advantage of a cross-linked membrane is that the membrane would absorb less water and would be less likely to dissolve at higher temperatures.

In a preferred embodiment, the polymerisation is carried out over a period of time such that a long chain polymer is formed, which is insoluble in water. It is preferred that the polymerisation is slow. This slow polymerisation forms a long-chain polymer that is soluble in a non-aqueous solvent, but is insoluble in water, which is advantageous for use in electrochemical cells.

A hydrophilic polymer of the invention (for use in the catalyst ink) is preferably insoluble in water. It is preferably soluble in a polar aprotic solvent, such as DMF or DMSO. By contrast most other ionomer formulations (e.g. Nafion®) are only soluble by phase inversion. The advantage of the hydrophilic polymers and catalyst inks of the invention is that the polymer is soluble in a solvent so that it can be made into an ink but is not soluble in water, so when made into an MEA will not dissolve in aqueous environments.

The hydrophilic polymer membranes of the type described in WO03/023890, or identical to those disclosed in WO03/023890, can be used as the hydrophilic polymer in the catalyst ink of the present invention. Surprisingly, curing the polymer slowly under a lower intensity light creates a polymeric material that is able to be dissolved in non-polar solvents (and polar aprotic solvents) but is insoluble in aqueous-based solvents. Without wishing to be bound by theory, it is thought that this is due to the increase in the chain length of the polymer polymerised under low-light conditions.

As used herein, the term “soluble” takes on its traditional meaning in the art, and will be understood by a person skilled in the art. It should be measured at standard temperature and pressure and preferably means that at least 99% of the solid is completely dissolved in the solvent.

Typically, the polymerisation is carried out by polymerising with UV radiation, for about 2 to 4 hours. In a preferred embodiment, the polymerisation is carried out slowly, such that the resulting polymer is a long-chain polymer. The long-chain polymer should not dissolve in water (i.e. insoluble in water), but should be able to dissolve in non-aqueous solvents (i.e. soluble in non-aqueous solvents). It is preferably soluble in polar aprotic solvents such as DMF and DMSO. It is preferably soluble in non-polar solvents.

The skilled person will be able to adjust the period of applying the radiation source, i.e. the UV lamp, in order to achieve this slow polymerisation. One way of ensuring that long-chain polymers are formed is to conduct the polymerisation slowly. Adjusting the time is one way to achieve this, but it may also be achieved by using a low power radiation source, such as a low-power UV lamp. An example of such a lamp is a Sylvania FSWF5BL350 UV lamp, and this is a particularly preferred embodiment of the invention.

In order to make the catalyst ink, the hydrophilic polymer is dissolved in a suitable solvent, as discussed above. The solvent is preferably a polar aprotic solvent such as DMF and DMSO. The resulting solution is preferably viscous, and preferably at a concentration of about 1%.

Preferably, the catalyst is Iridium Oxide, Ruthenium Oxide, Platinum Black or Platinum on Carbon.

The compositions of the invention are useful as catalyst inks, i.e. they can be sprayed or coated onto any existing membrane, which can then be used in an electrochemical cell, such as a fuel cell or an electrolyser.

All patents, patent applications, provisional applications, and publications referred to or cited herein are incorporated by reference in their entirety, including all figures and tables, to the extent they are not inconsistent with the explicit teachings of this specification.

The following Example illustrates the invention.

### EXAMPLE 1

A polymer was formed according to the formulation below:

Long Chain Polymer
Formulation
AMPSA: 6 g
Acrylonitrile; 15.7 g
Methyl Imidazole 2.4 g
UV Initiator 300 mg

Approx 3 ml of above mixture was sealed in a UHMWPE envelope (approx. 150×150 mm). It was pressed between two sheets of glass to form a flat film. It was then exposed to a Sylvania FSWF5BL350 UV light source for 2 to 4 hours.

The membrane was removed from the envelope and dissolved in a suitable solvent e.g. DMSO or DMF to form a viscous 1% solution.

The solution was then mixed with catalyst (although it could be directly cast into a film) and used as ink to make MEAs by painting (or spraying) onto a membrane or GDL.

The ink was deposited onto a membrane and the solvent removed by evaporation. Imidazole was removed from the MEA by exchanging with 1 molar sulphuric acid for two hours and then washing with several changes of pure water.

### EXAMPLE 2

In order to investigate the properties of the catalyst ink polymer, the ionomer formulation of the type disclosed in Example 1 was cast into a film and tested, without adding the catalyst. This enables the ionic properties to be accurately tested.

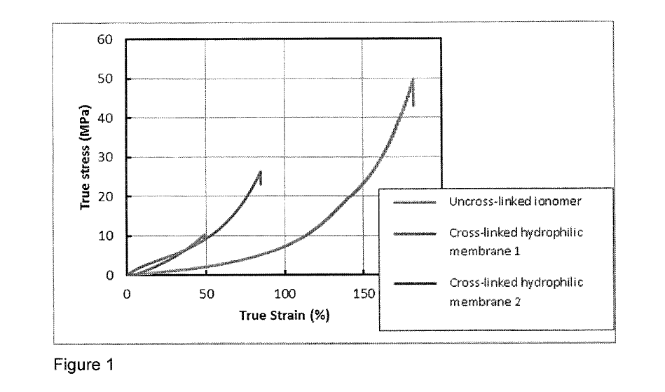

The formulation was cast into a thin sheet of similar dimensions to the hydrophilic membranes used in the test above. The strength of the membrane and ionic conductivity was measured. The results are shown in FIG. 1. The longest line in the graph is the uncross-linked ionomer, the second longest line is the cross-linked hydrophilic membrane 2, and the shortest line is the cross-linked hydrophilic membrane 1.

The energy required to break the uncross-linked membrane is 532 mJ compared to 238 mJ and 52 mJ for the cross-linked hydrophilic membranes.

The uncross-linked membrane also has a higher ion exchange capacity (IEC) and a high water content which is considered to be an important factor in improving conductivity. This is evidenced in the table below, and illustrates that the catalyst inks of the invention are particularly conductive.

| | Water | IEC | Conductivity |
|---|---|---|---|
| | content (%) | (mmol/g) | at 52° C. (mS/cm) |
| Cross-linked membrane 1 | ~50 | 1.135 | 62 |
| Cross-linked membrane 2 | 51.4 | 0.879 | 78 |
| Uncrosslinked ionomer | 71.5 | 1.152 | 142 |

We claim:

1. A method of forming a catalyst ink, the method comprising:
polymerising an ionic monomer and at least one non-ionic monomer to form a hydrophilic polymer;
dissolving the hydrophilic polymer in a suitable solvent to form a polymer solution; and
mixing a catalyst with the polymer solution to make a catalyst ink.

2. The method according to claim 1, wherein the ionic monomer is a monomer comprising an acid group or a basic group.

3. The method according to claim 2, wherein the acid group is a sulphonic acid group and/or the basic group is a quarternary ammonium group.

4. The method according to claim 1, wherein the ionic monomer is selected from 2-acrylamido-2-methyl-1-propanesulphonic acid (AMPSA), vinylsulphonic acid (VSA), styrenesulphonic acid (SSA), 2-sulphoethyl methacrylate (SOMA) and 3-sulphopropyl methacrylate, Na salt (SPM).

5. The method according to claim 1, wherein the at least one non-ionic monomer comprises a hydrophobic monomer.

6. The method according to claim 5, wherein the hydrophobic monomer is selected from methyl methacrylate (MMA), acrylonitrile (AN), methacryloxypropyltris (trimethylsiloxy) silane (TRIS), 2,2,2-trifluoroethyl methacrylate (TRIF) and styrene (STY).

7. The method according to claim 1, wherein the at least one non-ionic monomer comprises a hydrophilic monomer.

8. The method according to claim 7, wherein the hydrophilic monomer is selected from methacrylic acid (MA), 2-hydroxyethyl methacrylate (HEMA), ethyl acrylate (EA), 1-vinyl-2-pyrrolidinone (VP), propenoic acid 2-methyl ester (PAM), monomethacryloyloxyethyl phthalate (EMP) and ammonium sulphatoethyl methacrylate (SEM).

9. The method according to claim 1, wherein a cross-linker is added to the ionic monomer and at least one non-ionic monomer before polymerisation, wherein the cross-linker is such that it does not form a cross-linked polymer until after the polymer is dissolved.

10. The method according to claim 9, wherein the cross-linker is a silane monomer.

11. The method according claim 1, wherein the ionic monomer comprises an acid group, and wherein the acid group is reacted with methylimidazole before polymerisation to form an ionic liquid and then converted back to the acid group after polymerisation.

12. The method according to claim 1, wherein the catalyst is Iridium Oxide, Ruthenium Oxide, Platinum Black or Platinum on Carbon.

13. The method according to claim 1, wherein the polymerisation is carried out over a period of time such that a long chain polymer is formed that is insoluble in water, but soluble in a non-aqueous solvent.

14. The method according to claim 13, wherein the polymerisation is carried out by polymerising with UV radiation for about 2 to 4 hours.

15. The method according to claim 1, wherein the solvent in which the hydrophilic polymer is dissolved is a polar aprotic solvent.

16. The method according to claim 15, wherein the polar aprotic solvent is DMSO or DMF.

17. A catalyst ink formed using the method according to claim 1.

18. A method of forming a catalyst ink-coated membrane, the method comprising:
polymerising an ionic monomer and at least one non-ionic monomer to form a hydrophilic polymer;
dissolving the hydrophilic polymer in a suitable solvent to form a polymer solution;
mixing a catalyst with the polymer solution to make a catalyst ink;
depositing the catalyst ink onto a membrane; and
removing the solvent to form a catalyst ink-coated membrane.

19. The method according to claim 18, wherein the catalyst ink is deposited by spraying.

20. A catalyst ink-coated membrane formed from the method according to claim 18.

21. A membrane electrode assembly comprising the catalyst ink-coated membrane according to claim 20.
